(19) United States
(12) Patent Application Publication
(10) Pub. No.: US 2005/0169125 A1
(43) Pub. Date: Aug. 4, 2005

(54) Optical information storage apparatus and optical information storage system

(75) Inventor: Hiroki Kobayashi, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/093,780

(22) Filed: Mar. 30, 2005

Related U.S. Application Data
(63) Continuation of application No. PCT/JP03/06863, filed on May 30, 2003.

(51) Int. Cl. G11B 7/085

(52) U.S. Cl. 369/30.27

(57) ABSTRACT

An optical information storage apparatus incorporates a medium storage section that stores multiple optical storage media. An information reproducing section individually reproduces information from the optical storage media, and a medium moving section moves the optical storage medium between the medium storage section and the information reproducing section. A cleaning section is placed on a path along which the moving section moves the optical storage media. The cleaning section removes unwanted matter from the optical storage media as they are moved from the medium storage section to the information reproducing section. This prevents unwanted matter from entering the information reproducing section.

### BACKGROUND OF THE INVENTION

1. Technical Field

The present invention relates to an optical information storage apparatus which reproduces information from an optical storage medium on which at least information reproduction is optically executed and which cleans the optical storage medium, as well as an optical information storage system in which multiple optical storage apparatuses are integrated together.

2. Background Art

In view of a recent rapid progress in the information communication industry, it is excepted that there will be an explosive increase, in the near future, in the amount of data such as transaction information or homepage data which is communicated on a communication network typified by the Internet. Further, for example, new types of viruses have appeared one after another and an increasing number of crimes have been committed on the communication network. Accordingly, on the Internet or the like, logging has often been obligated. In view of these present circumstances and possible future demands, it is strongly desired that information storage apparatuses should increase capacities. The hard disk is a kind of massive information storage apparatus on and from which information can be read and written at high speed. However, due to high cost for an additional HD, an amount of information exceeding the capacity of the hard disk is forcibly discarded. A magnetic tape storage apparatus that is a kind of massive information storage apparatus can inexpensively realize a capacity larger than that of the hard disk. However, the magnetic tape is a sequential medium on and from which information is sequentially read and written. Accordingly, the magnetic tape cannot realize a sufficient I/O speed and is thus utilized only for applications for storing information for a long time.

To deal with an explosive increase in the amount of data expected in the near future, it is not enough to simply store a large amount of data and is desirable in the following fields to inexpensively achieve both the accumulation of information on the order of petabyte and high speed accesses within several seconds (what is called a near line access) in order to ensure an advanced retrieval capability in the following fields: the field of data mining in which an economic trend or the like is determined from a large amount of information such as sales information, the field of analysis of experimental data on atomic physics, the field of a collation technique using fingerprints or DNA information, the field of retrieval of patent information, the field of banks and securities, the field of electronic medical sheets, and the field of IDCs (Internet Data Centers).

Compared to the hard disk and magnetic tape, which have the above disadvantages, much attention is being paid to an optical information storage apparatus that stores information using an optical storage medium typified by an MO or a DVD. The reason will be described below. Information can be read from or written to the optical information storage apparatus at high speed. The capacity of the optical information storage apparatus is expected to increase sharply in the near future owing to technological revolution such as development of a blue laser diode or a surface recording system. It is also expected that a storage capacity comparable to that of the magnetic tape storage apparatus will be realized. Thus, the optical storage medium is considered to be a next-generation storage apparatus which operates at high speed and which has a large capacity.

Moreover, as the latest technique, there has been proposed an optical information storage apparatus incorporating following features in a housing: a magazine in which multiple optical storage media are stored, a driver that writes and reads information to and from the optical storage medium, and a changer that moves the optical storage medium between the magazine and the drive (hereafter such an optical information storage apparatus will be referred to as a multi-media storage apparatus). With such a multi-media storage apparatus, the capacity can be easily increased by providing more optical storage media or arranging multiple multi-media storage apparatuses side by side. Further, maintenance can be easily executed by detaching the magazine or the optical storage medium placed in a housing or replacing it with a new one.

Typically, an optical storage medium is irradiated with light from a head to record information on the medium. Further, the head receives light reflected from the optical storage medium so that information recorded on the optical storage medium can be reproduced on the basis of the reflected light. Accordingly, if the head is stained with dust or tar from cigarettes, the information cannot be read or written correctly. As a result, the performance of the optical information storage apparatus may be degraded.

In order to solve this problem, the following have been proposed: a method of installing a cleaning medium in the optical information storage apparatus to directly clean the head (see, for example, Patent Documents 1, 2, 3, 4, and 5), a method of using a cleaning drive or the like provided separately from a recording and reproducing drive to clean the optical storage medium, thus preventing unwanted matter from being introduced into the recording and reproducing drive (see, for example, Patent Documents 3, 4, and 6), and the like.

(Patent Document 1)

Japanese Patent Laid-Open No. 2000-93121

(Patent Document 2)

Japanese Patent Laid-Open No. 1993-54513

(Patent Document 3)

Japanese Patent Laid-Open No. 1993-74127

(Patent Document 4)

Japanese Patent Laid-Open No. 1993-114155

(Patent Document 5)

Japanese Patent Laid-Open No. 1995-235120

(Patent Document 6)

Japanese Patent Laid-Open No. 1999-45489

However, with the cleaning method using the cleaning medium, the cleaning medium is rotated in the drive, so that dust may be scattered. Further, since cleaning is repeatedly executed, the cleaning medium itself may be stained. Consequently, unwanted matter may adhere to the head again. If this method is applied to a multi-media storage apparatus in which multiple optical storage media are stored, the number of optical storage media that can be stored in the apparatus decreases owing to the mounted cleaning medium. Thus, disadvantageously, the storage capacity of the whole multi-media storage apparatus decreases.

The above problems are solved by using the cleaning drive to clean an optical storage medium to prevent unwanted matter from being introduced into a recording and reproducing drive. This method requires installation of the cleaning drive in addition to the recording and reproducing drive, thus requiring a larger and more complicated apparatus.

Either of the above methods requires an explicit operation or a complicated mechanism for cleaning, for example, an operator's instruction for starting cleaning or sensing of stain on the head or optical storage medium which triggers an instruction for cleaning. Although the head can be kept clean by carrying out cleaning more frequently, the cleaning disadvantageously reduces the amount of time available for the original operation of the storage apparatus. Therefore, an optical information storage apparatus is desirably developed which can carry out appropriate cleaning using a simpler mechanism.

### DISCLOSURE OF THE INVENTION

In view of the above circumstances, it is an object of the present invention to provide an optical information storage apparatus including a housing containing components and multiple optical storage media, the apparatus being able to carry out appropriate cleaning using a simple mechanism, as well as an optical information storage system in which multiple optical information storage apparatuses are integrated together.

To accomplish the object, the present invention provides an optical information storage apparatus including a box-like housing,
a medium storage section placed at one end of the housing to store multiple disk-like optical storage media on which information reproduction is executed at least optically,
an information reproducing section placed in the housing away from the medium storage section to reproduce information from each of the optical storage media,
a medium moving section placed between the medium storage section and the information reproducing section to move the optical storage medium between the medium storage section and the information reproducing section, and
a cleaning section placed on a path along which the medium moving section moves the optical storage medium, to remove unwanted matter from the optical storage medium.

With the optical information storage apparatus according to the present invention, unwanted matter adhering to the optical storage medium is removed before the optical storage medium is installed in the information reproducing section. This makes it possible to prevent unwanted matter from entering the information reproducing section. Further, the optical information storage apparatus according to the present invention does not require any cleaning drive for cleaning the optical storage medium. This inhibits an increase in the size of the apparatus. Further, in spite of a high cleaning frequency, the operation time of the storage apparatus is not affected.

Further, in the optical information storage apparatus, the optical storage media are arranged in the medium storage section with gaps each of which is disposed between two of the optical storage media. The medium storage section is also used as the cleaning section by placing a cleaning member in each of the gaps so that when the optical storage medium is loaded or unloaded, the cleaning member contacts with the optical storage medium to remove unwanted matter from the optical storage medium.

When cleaning members such as sheets are arranged as described above, every time the optical storage medium is loaded into or unloaded from the medium storage section, the cleaning member wipes unwanted matter away from the optical storage medium. This eliminates the need for an explicit operation or a complicated mechanism for cleaning and enables automatic cleaning using a simple mechanism.

Further, according to a preferred aspect of the optical information storage apparatus according to the present invention, the medium moving section is also used as the cleaning section by providing the medium moving section with cleaning members each of which contacts, when the corresponding optical storage medium is moved, with the optical storage medium to remove unwanted matter from the optical storage medium.

With the above medium moving section, every time the optical storage medium is moved between the optical storage medium and the information reproducing section, the cleaning member wipes unwanted matter away from the optical storage medium.

In a preferred aspect of the optical information storage apparatus according to the present invention, the cleaning members are sheets.

Dust or dirt adhering to the optical storage medium can be entangled in the cleaning members and wiped away.

In another preferred aspect of the optical information storage apparatus according to the present invention, the cleaning member is a brush. By using a brush as the cleaning member, it is possible to sweep away cotton dust or hairs which is likely to be collected in the housing.

Moreover, in the optical information storage apparatus according to the present invention, the medium storage section is detachably placed at one end of the housing,
the medium storage section, the medium moving section, and the information reproducing section are arranged in a line inside the housing so that the housing holds the medium storage section, the medium moving section, and the information reproducing section integrally with the cleaning section, and
a system housing in which a multiplicity of the optical information storage apparatuses are mounted further includes a connecting section that detachably connects the optical information storage apparatuses to the system housing.

According to the optical information storage apparatus of the present invention, the medium storage section, the medium moving section, and the information reproducing section are compactly accommodated in the housing. Consequently, the capacity of the system can be easily increased by providing more optical information storage apparatuses. Further, maintenance can be easily executed by detaching the medium storage section or optical storage medium, placed at one end of the housing, from the housing or replacing it with a new one.

Moreover, the present invention provides an optical information storage system including multiple optical information storage apparatuses each having a box-like housing, a medium storage section placed at one end of the housing to store multiple disk-like optical storage media on which information reproduction is executed at least optically, an information reproducing section placed in the housing away from the medium storage section to reproduce information from each of the optical storage media, a medium moving section placed between the medium storage section and the information reproducing section to move the optical storage medium between the medium storage section and the information reproducing section, and a cleaning section placed on a path along which the medium moving section moves the optical storage medium, to remove unwanted matter from the optical storage medium,
a system housing in which the multiple optical information storage apparatuses are detachably mounted, and
a control section that controls recording and/or reproduction of information on and/or from each of the multiple optical storage media mounted in the system.

The optical information storage system according to the present invention includes the multiple optical information storage apparatuses each having the housing in which the medium storage section, the information reproducing section, and the medium moving section are compactly accommodated. This makes it possible to construct a compact and massive storage system. Moreover, the optical storage media stored in each of the optical information storage apparatuses can be appropriately cleaned using a simple mechanism. Further, the capacity of the system can be easily increased by providing more optical storage media or optical information storage apparatuses. Maintenance can also be easily executed by detaching the medium storage section or the optical information storage apparatus or replacing it with a new one.

### BRIEF DESCRIPTION OF THE DRAWINGS

FIG. 1 is a diagram showing the appearance of each of embodiments of an optical information storage system and an optical information storage apparatus according to the present invention;

FIG. 2 is a diagram illustrating the hardware structure of a blade apparatus;

FIG. 3 is a functional block diagram showing the functional structure of a blade apparatus;

FIG. 4 is a diagram illustrating the internal structure of a magazine;

FIG. 5 is a diagram illustrating the structure of vicinity of a head in a drive;

FIG. 6 is a flowchart illustrating a series of operations of writing or reading information to or from an MO disk;

FIG. 7 is a diagram showing an MO disk and a sheet and in which the MO disk is taken out of the magazine;

FIG. 8 is a diagram showing the interior of a magazine according to a second embodiment of the present invention;

FIG. 9 is a diagram showing the interior of a magazine according to a third embodiment of the present invention; and

FIG. 10 is a diagram illustrating the hardware structure of a blade apparatus according to a fourth embodiment of the present invention.

### BEST MODE FOR CARRYING OUT THE INVENTION

Embodiments of the present invention will be described below.

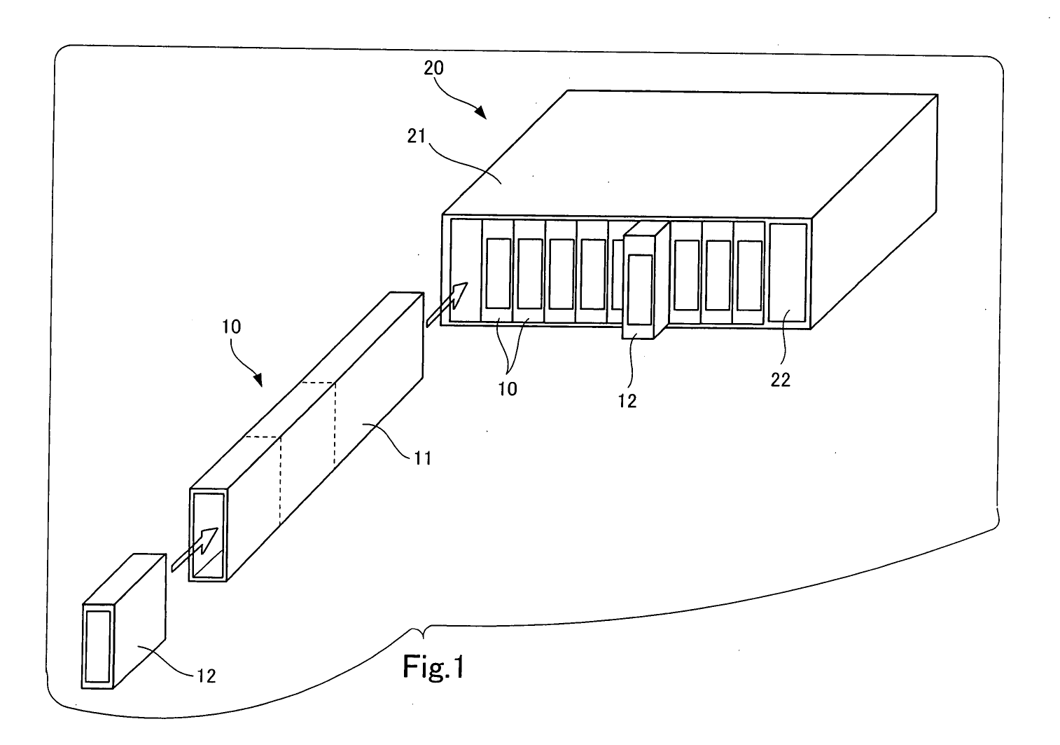

FIG. 1 is a diagram showing the appearance of each of embodiments of an optical information storage system and an optical information storage apparatus according to the present invention.

FIG. 1 shows a blade apparatus 10 corresponding to the embodiment of the optical information storage apparatus according to the present invention and an collective system 20 corresponding to an embodiment of the optical information storage system according to the present invention; the blade apparatus 10 uses an magneto-optic (MO) disk as an example of an optical storage medium according to the present invention, and the collective system 20 contains multiple (in this figure, ten units of) blade apparatuses 10.

A housing 11 of the blade apparatus 10 has a length that is more than 2.5 times as large as the diameter of the MO disk, a width (in this figure, height) that is slightly larger than the diameter of the MO disk, and a thickness (in this figure, width) that is significantly smaller than the diameter of the MO disk. A magazine 12 is detachably placed at one end of the housing 11; multiple MO disks are housed in the magazine 12. The housing 11 is an example of a housing according to the present invention. The magazine 12 corresponds to an example of a medium storage section according to the present invention.

Multiple blade apparatuses 10 are releasably mounted in a housing 21 of the collective system 20. The magazine 12 in each blade apparatus 10 is detachable even when the blade apparatus 10 has been inserted into the housing 21 of the collective system 20. Further, the collective system 20 includes a control device 22 that controls recording and reproduction of information in each of the multiple blade apparatuses 10.

In the collective system 20, the multiple blade apparatuses 10 are compactly housed in the housing 21, thus constituting a compact and massive storage system. The capacity of the system can be easily increased by providing more MO disks or blade apparatuses 10. Further, maintenance can also be easily executed by detaching the magazine 12 or blade apparatus 10 from the system or replacing it with a new one.

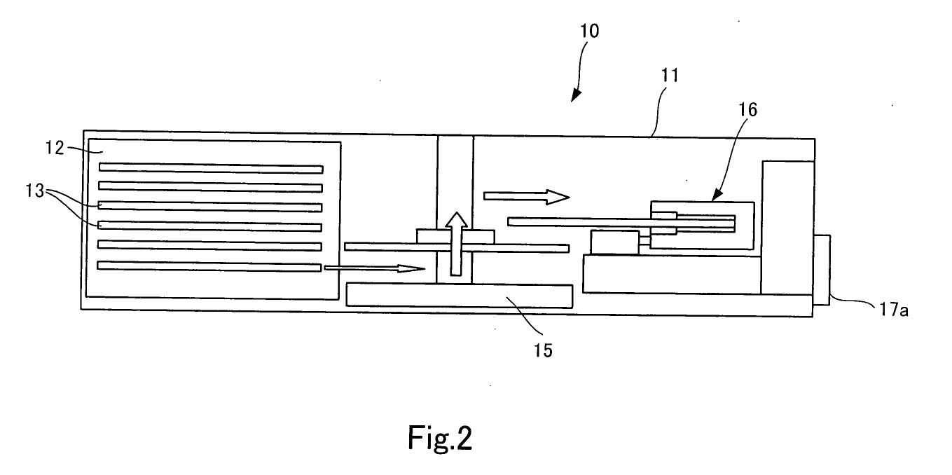

FIG. 2 is a diagram illustrating the hardware structure of the blade apparatus.

The blade apparatus 10, also shown in FIG. 1, has the magazine 12, and a drive 16 that records and reproduces information on and from an MO disk 13, the magazine 12 and drive 16 being provided in the housing 11. A changer 15 is provided between the magazine 12 and the drive 16 to move the MO disk 13 between them. The drive 16 corresponds to an example of an information reproducing section according to the present invention. The changer 15 corresponds to an example of a medium moving section according to the present invention.

An interface connector 17a is provided at an end of the blade apparatus 10 which is opposite the magazine 12; the interface connector 17a transfers data between the blade apparatus 10 and an external device. When the blade apparatus 10 is inserted into a housing 21 of the collective system 20, shown in FIG. 1, the connector 17a is joined to a connector of the collective system 20. The connector 17a corresponds to an example of a connecting section according to the present invention.

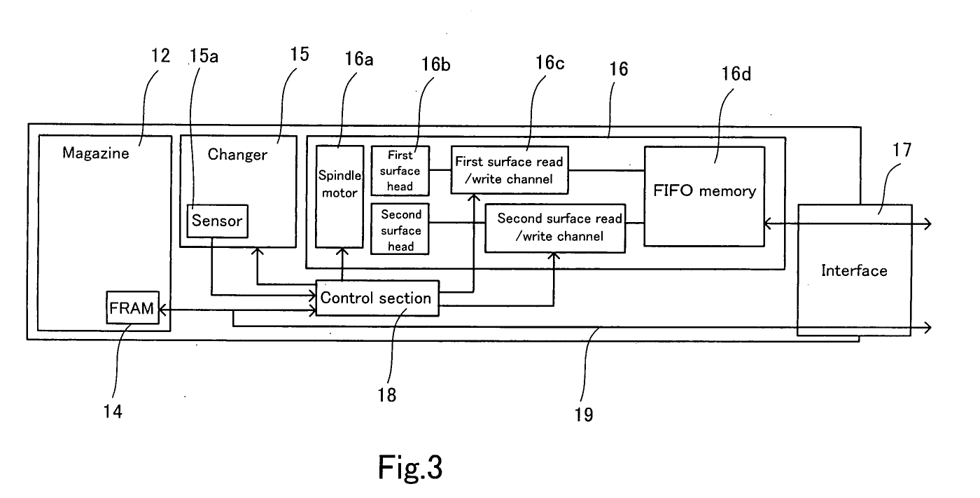

FIG. 3 is a functional block diagram showing the functional structure of a blade apparatus.

As described above, the blade apparatus 10 comprises the magazine 12, the changer 15, and the drive 16. The blade apparatus 10 further comprises a control section 18 that controls the changer 15 and the drive 16, and an interface 17 corresponding to the connector 17a, shown in FIG. 2, and transferring data between the blade apparatus 10 and an external device. The interface 17 is selected from well-known high-speed serial interfaces such as IEEE 1394, USB, and serial ATA. The detailed description of the interface 17 is omitted.

The drive 16 is provided with a spindle motor 16a that holds and rotates the MO disk 13 and a head 16b that irradiates the MO disk 13 with laser light to record and reproduce information on and from the MO disk 13. The head 16b is provided for each of a first and second surfaces (front and back surfaces) of the MO disk. Further, the drive 16 is provided with a read/write channel 16c and a first-in first-out (FIFO) memory 16d for each of the first and second surfaces; the first-in first-out (FIFO) memory 16d functions as a buffer.

Further, the magazine 12 is provided with an FRAM 14 that stores the disk number of the stored MO disk 13 and information on the address at which the MO disk 13 is stored.

When specific information indicating an MO disk is externally specified using a path (not shown) via the interface 17, the control section 18 finds the MO disk 13 indicated by the specific information, on the basis of information stored in the FRAM 14. The control section 18 then indicates the MO disk 13 found to the changer 15. Then, the changer 15 takes the MO disk 13 specified by the control section 18, out of the magazine 12. The changer 15 then loads the MO disk 13 into the drive 16.

Further, the blade apparatus 10 is provided with an access path 19 along which an external device directly accesses the FRAM 14 without passing through the control section 18. Even if the blade apparatus has been powered off, the information stored in the FRAM 14 can be externally checked.

The blade apparatus 10 is basically connected to the collective system 20 in such a manner.

Now, components of the blade apparatus 10 will be described in detail.

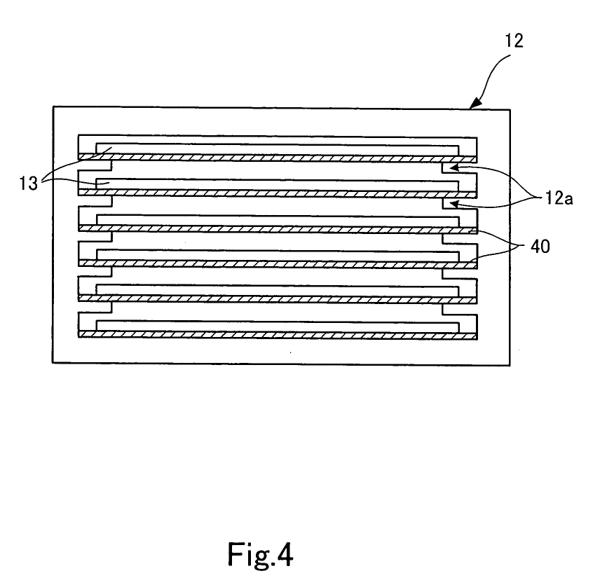

FIG. 4 is a diagram illustrating the internal structure of the magazine 12.

The magazine 12, also shown in FIGS. 2 and 3, is provided with multiple guide projections 12a used to hold multiple MO disks 13. A sheet 40 composed of a non-woven fabric is affixed to one surface of each of the guide projections 12a. Each MO disk 13 is placed on the corresponding guide projection one by one so that the MO disks 13 are stored at intervals. One surface (in this example, back surface) of each MO disk 13 is in contact with the sheet 40. The magazine 12 corresponds to an example of a medium storage section according to the present invention and is also used as an example of a cleaning section according to the present invention. Further, the sheet 40 corresponds to an example of a cleaning member according to the present invention as well as an example of a sheet according to the present invention.

The changer 15, shown in FIGS. 2 and 3, has a function for inserting and removing the MO disk 13 into and from the magazine 12, a function for moving the MO disk 13 in the vertical direction of the figure, and a function for loading and unloading the MO disk 13 into and from the drive 16.

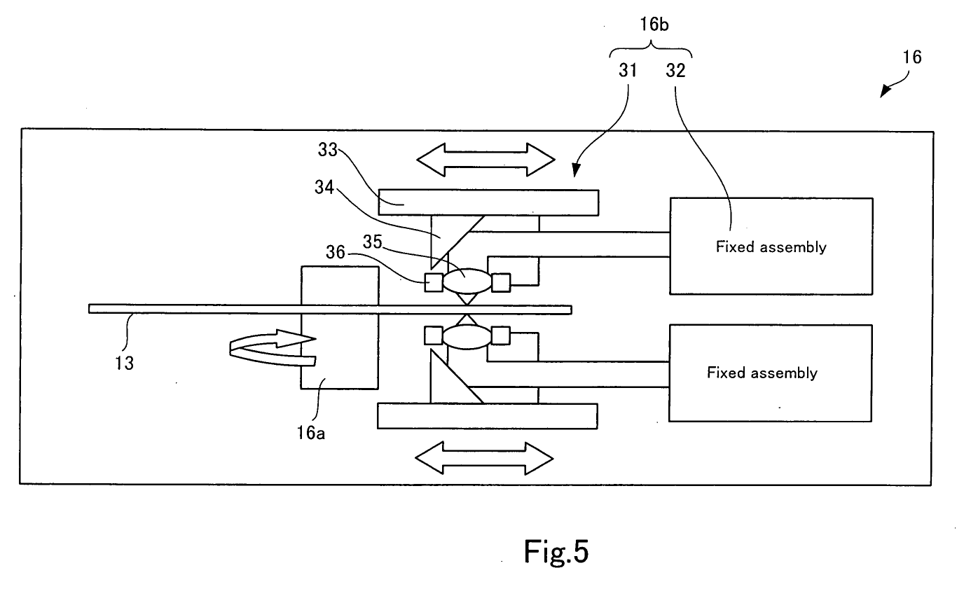

FIG. 5 is a diagram illustrating the structure of vicinity of the head in the drive.

The drive 16, also shown in FIGS. 2 and 3, is provided with two heads 16b. FIG. 5 shows the structure of vicinity of the two heads 16b. The two heads 16b are arranged so as to sandwich the MO disk 13; the MO disk 13 is held and rotated by a spindle motor 16a. Each of the heads 16b is composed of a fixed assembly 32 containing a laser diode, a light sensing element, and various optical elements to generate laser light for recording and reproduction and sense various signals described later, a movable assembly (carriage) 31 that moves on a predetermined rail to irradiate a desired position of the MO disk 13 with laser light and return light reflected by the MO disk 13 to the fixed assembly 32, and a control section (not shown) that controls each of the elements in FIG. 5. Moreover, the movable assembly 31 includes a carriage base 33, a rising mirror 34 that reflects laser light, a condenser lens 35 that concentrates laser light on the MO disk 13, and a lens actuator 36 that moves the condenser lens 35.

Now, the description will shift from the components of the blade apparatus 10 to the various signals detected by the fixed assembly 32.

Although not shown, the fixed assembly 32 contains a beam splitter and a prism. The fixed assembly 32 divides light reflected by the MO disk 13 into three lights for focus control, track control, and MO signals.

The focus control light is used for focus control that maintains a fixed distance between the condenser lens 35 and the MO disk 13. The MO disk 13 is rotated by the spindle motor 16a at high speed. Accordingly, the distance between the MO disk 13 and the condenser lens 35 is prone to vary. When the distance between the condenser lens 35 and the MO disk 13 deviates from a focusing distance, positions on the MO disk 13 which are different from the desired one are irradiated with laser light condensed by the condenser lens 35. Thus, disadvantageously, information cannot be correctly read or written. The fixed assembly 32 senses a signal (FES: Focus Error Signal) indicating how the distance between the MO disk 13 and the condenser lens 35 deviates from the focusing distance. The lens actuator 36 for the condenser lens 35 corrects the position of the condenser lens 35 in accordance with the FES.

The track control light is used for track control that moves laser light condensed by the condensing lens 35 to a position to and from which information on the MO disk 13 is written or read and maintains the laser light at the position. The focus control is an operation of controlling the position of the condenser lens 35 in the direction of its height. In contrast, the track control is an operation of controlling the position of the condenser lens 35 in its lateral direction. For example, if the MO disk 13 is rotated at high speed and shaken in the lateral direction and beam light is not concentrated at the center of tracks on the MO disk 13, information may be read from or written to an incorrect position on the MO disk 13. For the purpose of preventing such an error, a signal (TES: Track Error Signal) is detected in the track control light; the signal indicates a difference between the position of laser light condensed by the condenser lens 35 and the center of the tracks on the MO disk 13. The lens actuator 36 corrects the position of the condenser lens 35 in accordance with the TES.

An MO signal indicating information read from or written to the MO disk 13 is detected in the MO signal light. Information recorded on the MO disk 13 is read on the basis of the MO signal.

In this case, when dust or dirt adheres to the drive 16, shown in FIG. 5, notably to the vicinity of its condenser lens 35, reflected light from the MO disk 13 may not be sufficiently received. This may preclude the correct focus control or track control or inhibit information from being read or written from the MO disk 13.

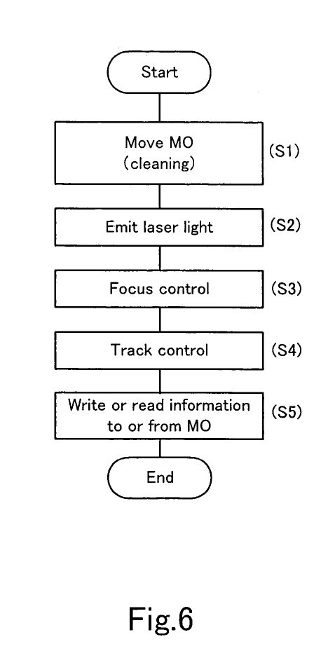

In the blade apparatus of the present embodiment, FIG. 6 is a flowchart illustrating a series of operations of writing or reading information to or from an MO disk. With reference to the flowchart in FIG. 6, description will be given of a series of operations of cleaning the MO disk 13 to remove unwanted matter from it and then writing or reading information to or from the MO disk 13.

The MO disk 13 stored in the magazine 12, shown in FIGS. 2 and 4, is taken by the changer 15 out of the magazine 12.

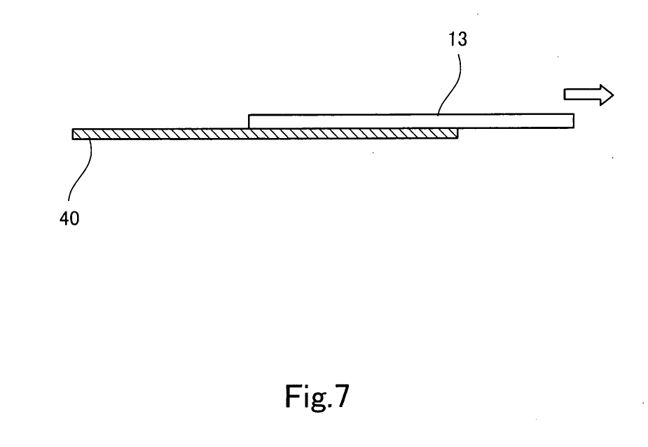

FIG. 7 is a diagram showing the MO disk and the sheet and in which the MO disk is taken out of the magazine.

As also shown in FIG. 4, the MO disk 13 stored in the magazine 12 has one surface in contact with the sheet 40. The changer 15 moves the MO disk 13 to the drive 16 while keeping the disk 13 in contact with the sheet 40. On this occasion, unwanted matter is removed from the surface of the MO disk 13 which is in contact with the sheet 40 (step S1 in FIG. 6).

The MO disk 13 is carried to the drive 16 as it is, and is then installed in the drive 16. Unwanted matter has already been removed from the installed MO disk 13 to prevent the entry of such matter into the drive 16. The MO disk 13 installed in the drive 16 is held and rotated by the spindle motor 16, shown in FIG. 5.

Rotation of the MO disk 13 causes the fixed assembly 32 to generate laser light. The condenser lens 35 of the movable assembly 31 concentrates the laser light at a predetermined position on the disk (step S2 in FIG. 6).

The laser light condensed by the condenser lens 35 is reflected by the disk. The reflected light is transmitted from the movable assembly 31 to the fixed assembly 32. The fixed assembly 32 divides the reflected light into focus control light, track control light, and MO signal light. Moreover, an FES, a TES, and an MO signal are detected in these lights.

These signals are continually detected every specified time while the MO disk 13 is rotating. First, of these signals, the FES is used to execute the above series of focus control operations (step S3 in FIG. 6). The distance between the condenser lens 35 and the MO disk 13, shown in FIG. 5, is maintained at a fixed value.

Subsequently, of the detected signals, the TES is used to perform the above track control (step S4 in FIG. 6). The beam light condensed by the condenser lens 35 in FIG. 5 follows the center of the tracks on the MO disk 13.

After the focus control and the track control have been performed, a read or write is executed on the MO disk 13 on the basis of the MO signal detected in this state (step S5) The above series of operations enable the correct read or write to be executed on the MO disk 13.

Thus, with the blade apparatus according to the present embodiment, every time the MO disk 13 is taken out of the magazine 12, unwanted matter adhering to the MO disk 13 is wiped away. This eliminates the need for an explicit operation or a complicate mechanism for cleaning. It is also possible to execute appropriate cleaning with the simple mechanism.

In the description of the above example, only the MO disks 13 are stored in the magazine 12. However, a conventional cleaning disk may also be stored in the magazine 12 together with the MO disks 13; the cleaning disk is installed in and rotated by the drive 16 to clean the head 16b. By thus storing the cleaning disk in the magazine 12, it is possible to directly clean the head 16b to keep the head 16b cleaner. Further, dust or dirt adhering to the cleaning disk is removed using the sheet 40. Consequently, the cleaning disk can be repeatedly used.

The first embodiment of the present invention has been described. Now, a second embodiment of the present invention will be described. For the purpose of avoiding duplication, elements configured in the same manner as in the first embodiment are denoted by the same reference numerals and characters. The description will focus on differences from the first embodiment.

The second embodiment is configured similarly to the first embodiment, shown in FIG. 2, except for the positions of sheets stuck inside the magazine.

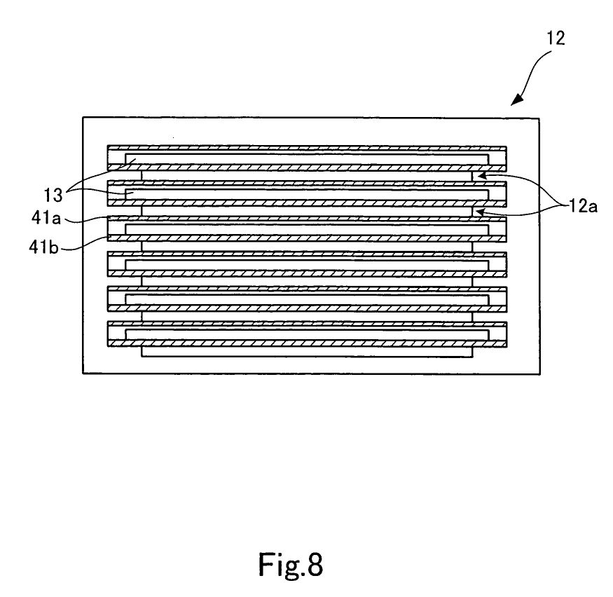

FIG. 8 is a diagram showing the interior of a magazine according to the second embodiment of the present invention.

In the magazine 12 according to the second embodiment, shown in FIG. 8, sheets are stuck to both sides, instead of one side, of each guide projection 12a in contrast to the first embodiment, shown in FIG. 4.

When the magazine 12 according to the present embodiment, shown in FIG. 8, is applied in place of the magazine 12 according to the first embodiment, shown in FIGS. 2 and 4, both sides of the MO disk 13 can be cleaned by, for example, moving the MO disk 13 with its top surface in contact with a sheet 41a when the MO disk 13 is taken out of the magazine 12, and moving the MO disk 13 with its bottom surface is in contact with the sheet 41b when the MO disk 13 is stored in the magazine 12.

The second embodiment of the present invention has been described. Now, a third embodiment of the present invention will be described. The third embodiment is configured similarly to the first embodiment, shown in FIG. 2, except for the positions of sheets stuck inside the magazine.

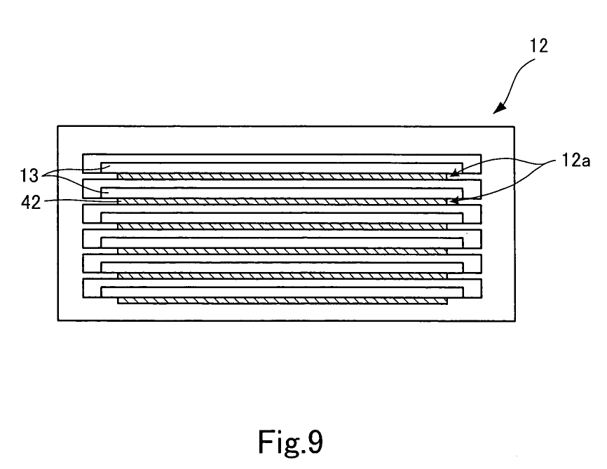

FIG. 9 is a diagram showing the interior of a magazine according to the third embodiment of the present invention.

In the magazine 12 according to the third embodiment, shown in FIG. 9, a sheet 42 almost as thick as the guide projection 12a is stuck to the guide projection 12a so as to connect to it.

When the magazine 12 according to the present embodiment is applied in place of the magazine 12 shown in FIGS. 2 and 4, both sides of the MO disk 13 can be cleaned with fewer cleaning members by, for example, moving the MO disk 13 with its top surface in contact with the sheet 42 when the MO disk 13 is taken out of the magazine 12, and moving the MO disk 13 with its bottom surface is in contact with the sheet 42 when the MO disk 13 is stored in the magazine 12.

The third embodiment of the present invention has been described. Now, a fourth embodiment of the present invention will be described. In the above first, second, and third embodiments, the cleaning members are stuck inside the magazine. However, according to the present embodiment, a cleaning member is mounted on the changer.

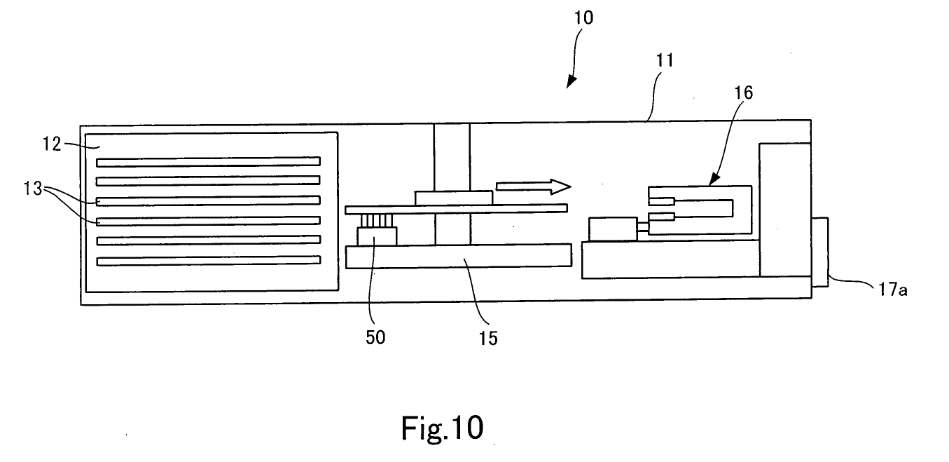

FIG. 10 is a diagram illustrating the hardware structure of a blade apparatus according to the fourth embodiment of the present invention.

The third embodiment is configured similarly to the first embodiment, shown in FIG. 2, except that in the blade apparatus 10 according to the present embodiment, a brush 50 is provided on the changer 15. The changer 15 corresponds to an example of a medium moving section according to the present invention and is also used as an example of a cleaning section according to the present invention. Further, the brush 50 corresponds to an example of a cleaning member according to the present invention as well as an example of a brush according to the present invention.

The brush 50 is fixed to a position on the changer 15 where it comes into contact with the MO disk 13 when the MO disk 13 is taken out of the magazine 12. When the MO disk 13 is taken out of the magazine 12, the changer 15 moves the MO disk 13 in the lateral direction to the drive 16 so that the MO disk 13 is in contact with the brush 50. On this occasion, the brush 50 sweeps away dust or dirt adhering to the MO disk 13. This prevents dirt or dust from disadvantageously entering the drive 16.

In this manner, the cleaning member may be provided on the changer rather than in the magazine.

The embodiments of the present invention have been described.

In the above description, the MO disk is shown as an example of an optical storage medium according to the present invention. However, the optical storage medium according to the present invention may be a DVD or the like.

Further, the optical information storage apparatus described above can simultaneously access both surfaces of the MO disk. However, the optical information storage device according to the present invention may access only one side of the optical storage medium.

In the above example, the sheet of a non-woven fabric or the brush is used as a cleaning member. However, the cleaning member according to the present invention may be, for example, a sponge.

Moreover, in the above example, the cleaning member such as a sheet or a brush as the cleaning section of the optical information storage apparatus according to the present invention wipes unwanted matter away from the optical storage medium. However, the cleaning section of the optical information storage apparatus according to the present invention may include an air injector that injects clean air, to blow unwanted matter away from the optical storage medium.

1. An optical information storage apparatus comprising:
a box-like housing;
a medium storage section placed at one end of the housing to store a plurality of disk-like optical storage media on which information reproduction is executed at least optically;
an information reproducing section placed in the housing away from the medium storage section to reproduce information from each of the optical storage media;
a medium moving section placed between the medium storage section and the information reproducing section to move the optical storage medium between the medium storage section and the information reproducing section; and
a cleaning section placed on a path along which the medium moving section moves the optical storage medium, to remove unwanted matter from the optical storage medium.

2. The optical information storage apparatus according to claim 1, wherein the optical storage media are arranged in the medium storage section with gaps, each of the gaps being disposed between two of the optical storage media, and the medium storage section is also used as the cleaning section by placing a cleaning member in each of the gaps so that when the optical storage medium is loaded or unloaded, the cleaning member contacts with the optical storage medium to remove unwanted matter from the optical storage medium.

3. The optical information storage apparatus according to claim 1, wherein the medium moving section is also used as the cleaning section by providing the medium moving section with cleaning members each of which contacts, when the optical storage medium is moved, with the optical storage medium to remove unwanted matter from the optical storage medium.

4. The optical information storage apparatus according to claim 2, wherein the cleaning members are sheets.

5. The optical information storage apparatus according to claim 2, wherein the cleaning member is a brush.

6. The optical information storage apparatus according to claim 1, wherein the medium storage section is detachably placed at one end of the housing,
the medium storage section, the medium moving section, and the information reproducing section are arranged in a line inside the housing so that the housing holds the medium storage section, the medium moving section, and the information reproducing section integrally with the cleaning section, and
a system housing in which a plurality of the optical information storage apparatuses are mounted further comprises a connecting section that detachably connects the optical information storage apparatuses to the system housing.

7. An optical information storage system comprising:
a plurality of optical information storage apparatuses each having a box-like housing, a medium storage section placed at one end of the housing to store a plurality of disk-like optical storage media on which information reproduction is executed at least optically, an information reproducing section placed in the housing away from the medium storage section to reproduce information from each of the optical storage media, a medium moving section placed between the medium storage section and the information reproducing section to move the optical storage medium between the medium storage section and the information reproducing section, and a cleaning section placed on a path along which the medium moving section moves the optical storage medium, to remove unwanted matter from the optical storage medium;
a system housing in which the plurality of optical information storage apparatuses are detachably mounted; and
a control section that controls recording and/or reproduction of information on and/or from each of the plurality of optical storage media mounted in the system housing.

8. The optical information storage apparatus according to claim 3, wherein the cleaning members are sheets.

9. The optical information storage apparatus according to claim 3, wherein the cleaning member is a brush.
